(19) United States
(12) Patent Application Publication
(10) Pub. No.: US 2009/0152032 A1
(43) Pub. Date: Jun. 18, 2009

(54) ATTACHMENT DEVICE OF A COMBINED MODULE CONSISTING OF AN ACCUMULATOR AND INTERNAL HEAT EXCHANGER

(76) Inventors: Thomas Klotten, Koln (DE); Balthasar Schillemeit, Bonn (DE); Michael Fietz, Aachen (DE)

Correspondence Address: FRASER CLEMENS MARTIN & MILLER LLC, 28366 KENSINGTON LANE, PERRYSBURG, OH, 43551, US

(21) Appl. No.: 11/924,679

(22) Filed: Oct. 26, 2007

(30) Foreign Application Priority Data
Oct. 27, 2006 (DE) 10 2006 051383.5

(51) Int. Cl. B60K 11/04

(52) U.S. Cl. 180/68.4; 248/638

(57) ABSTRACT

The invention relates to an attachment device of a combined module consisting of an accumulator and internal heat exchanger for use in mobile air conditioning systems with the CO₂ coolant R744 on the body of a motor vehicle. The combined module is indirectly connected with mounts which are rigidly secured to the body using oscillation-damping decoupling elements.

### CROSS-REFERENCE TO RELATED APPLICATION

This application claims the benefit of German Patent Application No. 102006051383.5 ATTACHMENT DEVICE OF A COMBINED MODULE CONSISTING OF AN ACCUMULATOR AND INTERNAL HEAT EXCHANGER filed on Oct. 27, 2006, hereby incorporated herein by reference in its entirety.

### FIELD OF THE INVENTION

The invention relates generally to an attachment device of a combined module consisting of an accumulator and internal heat exchanger for use in mobile air conditioning systems with the CO₂ coolant R744 on the body of a motor vehicle, and more particularly a decoupling element that facilitates an efficient vibration isolation in spite of the higher weight load of the combined module.

### BACKGROUND OF THE INVENTION

Coolant R134a, which consists of a partially fluorinated hydrofluorocarbon, is slated to be replaced by the CO₂ coolant R744 in the future for mobile applications, in particular in motor vehicle air conditioning systems. One pivotal advantage of coolant R744 lies in the GWP value (global warming potential) of just 1, which is substantially lower in comparison to the GWP value for R134a. Another advantage involves the lower fuel consumption at the same generated refrigerating capacity. In addition, the components used in air conditioning systems based on R744 are substantially smaller than those with R134a.

Disadvantages when using R744 as opposed to R134a include the higher temperature level on the high-pressure side and the higher pressures encountered both with the entire system idle and during operation on the high-pressure and low-pressure side. For example, maximum pressures of up to 12 MPa arise during idling at an engine compartment temperature of 125□C. Since the strength of aluminum diminishes in this temperature range and air conditioning system components are rated for a double safety margin, relatively thick walls are required for R744 accumulators. This also results in a relatively high component weight by comparison to the R134a components. Another complication for a combined module consisting of an accumulator and internal heat exchanger AccuIHE) is that the weight is additionally increased by that of the internal heat exchanger (IHE). The weight of the combined module comprised of accumulator and internal heat exchanger (AccuIHE) measures around 1700 grams without coolant and oil.

The coolant pressure pulsations generated by the coolant compressor and streaming noises present in the circulating coolant induce oscillations in the air conditioning system components. As a result, it becomes necessary to acoustically decouple the coolant components and lines of the air conditioning system from the vehicle. The noise and oscillation behavior of an R744 coolant circulating system demands more attention given the higher pressure pulsation and lower sound velocity of R744 by comparison to R134a. The higher component weight when using R744 yields a critical frequency range that is lower than when using R134a. As a result, softer decoupling elements are required when using R744. This gives rise to special requirements for systems used to attach a combined module consisting of an accumulator and internal heat exchanger (AccuIHE) based on R744. On the one hand, decoupling must be ensured, e.g., by soft rubber elements. On the other hand, however, there is a problem of the decoupling elements exerting a high load owing to the module weight.

In conventional attachment systems designed for R134a accumulators, rubber elements that directly abut the holding devices and cushion them directly against the body are used for decoupling purposes. In one exemplary design according to prior art, the cylindrical accumulator is annularly enveloped by a holding device, which also exhibits an attachment projection that runs tangential to the ring line. This attachment projection has an attachment opening. The holding device is secured to the body wall by means of an attachment element leading into the body wall through the attachment opening and an opening congruent with the latter. The attachment projection, body wall and attachment element here have no direct contact with each other, but are rather cushioned against one another in all three oscillation directions X, Y, Z by a rubber element provided for decoupling purposes, which envelops the attachment element and also shifts between the head of the attachment element and the attachment projection on the one hand, and between the attachment projection and the body wall on the other.

The main load on the combined module is exerted in the direction of primary vehicle axis Z. The decoupling elements must be tightened or compressed to a corresponding extent to avoid damages from oscillations in the direction of the Z-axis. The decoupling elements can become compacted and hardened as a result. Because of this, the there is a danger that the decoupling elements might lose their ability to attenuate low-frequency oscillations. By contrast, low tightening torques would cause damage to the decoupling elements owing to the high load.

DE 200 05 887 U1 describes a strap mount for a coolant pressure tank of a vehicle air conditioning system, in particular a dryer or an accumulator. On the one hand, this strap mount has consoles that exhibit attachment openings used for attachment to the body. On the other hand, the strap mount exhibits at least one strap that can be clamped around the pressure tank with a seal. In this case, the strap has a quick-acting toggle-type fastener with integrated positively locking elements for clamping and retaining. Since this quick-acting toggle-type fastener integrates all components necessary for its function, no additional attachment element is required that might loosen during exposure to the operationally induced heat and vibration. However, the strap mount according to DE 200 050 887 U1 does not provide for oscillatory decoupling.

Accordingly, it would be desirable to produce a a decoupling element that facilitates an efficient vibration isolation in spite of the higher weight load of the combined module.

### SUMMARY OF THE INVENTION

Harmonious with the present invention, a decoupling element for use with a combined module consisting of a refrigerant accumulator and a heat exchanger, wherein a decoupling element that facilitates an efficient vibration isolation in spite of the higher weight load of the combined module, has surprisingly been discovered.

In one embodiment, the lower mount is attached at one end to the body side without a decoupling element and the second end of the mount is joined by a decoupling element with the combined module. The primary load imposed by the module weight takes place in the direction of the longitudinal axis of the combined module. The decoupling element is arranged in the direction of the primary axis Z, and dampens oscillations in the direction of primary axis Z. The mount has a sickle shape, the surface of which is aligned perpendicular to the longitudinal axis of the combined module. A first end of the sickle-shaped mount is located under the combined module, from where the sickle-shaped mount extends laterally, with its second outer end facing away from the combined module. In the area of the first outer end of the sickle-shaped mount, the outer surface of the sickle-shaped mount accommodates an attachment projection of the mount for fastening to the bottom side of the cylindrical decoupling element. The attachment projection of the mount is secured to the decoupling element with an attachment element, wherein the attachment element is introduced from below into the cylindrical decoupling element through an attachment opening in the attachment projection of the mount, parallel to the longitudinal axis of the combined module. An upper mount may be used where the shape is circular and receives the combined module while retaining an annular gap therebetween. Additional decoupling elements may be placed within the annular gap to provide damping in multiple axises.

In a particularly advantageous embodiment, the weight of the combined module is transmitted by a clamping ring and a mount to the decoupling element which is positioned eccentrically parallel to the primary axis Z. The clamping ring has an attachment projection, the attachment opening of which lies flat on the surface of the cylindrical decoupling element. On the opposing lower side of the decoupling element, the attachment opening of the mount is coaxially positioned with the attachment opening of the attachment projection on the clamping ring. An attachment element extends longitudinally through the cylindrical decoupling element and both attachment openings. The attachment element is designed as a screw bolt in the embodiment which accommodates screw nuts installed onto both the attachment projection on the clamping ring and on the mount. The mount is essentially C-shaped with a lower C-leg, a C-base leg and an upper C-leg. The attachment opening of the mount to be secured to the decoupling element is located on the lower C-leg. The upper C-leg exhibits an attachment projection extending laterally out of the latter for securing the mount to the vehicle body, wherein the attachment is formed without directly decoupling.

Additionally, the decoupling element may be designed to have a progressive spring characteristic wherein the decoupling element has annular gaps formed therein and is positioned between any of the mounts and the combined module.

The significant advantage and feature of the invention over the prior art is essentially an efficient decoupling of the combined module from the vehicle body. A special arrangement of decoupling elements leads to the possibility to tune the decoupling system exactly to the demands of weight, size, and vibration level that is not possible with prior art design.

### BRIEF DESCRIPTION OF THE DRAWINGS

The above and other objects and advantages of the invention will become readily apparent to those skilled in the art from reading the following descriptions of several embodiments of the invention when considered in the light of the accompanying drawings in which:

FIG. 1 is a cross section of a system for attaching R134a-accumulators with decoupling element according to the prior art;

FIG. 2 is a combined module with mounts and decoupling elements according to an embodiment of the invention;

FIG. 3 is a combined module with eccentric Z-axis decoupling according to an embodiment of the invention; and

FIG. 4 is a cross section of a combined module with a coaxially arranged decoupling element according to an embodiment of the invention, wherein FIG. 4a depicts a section along the X-Z plane of the combined module and FIG. 4b depicts a section along the X-Y plane.

### DETAILED DESCRIPTION THE INVENTION

The following detailed description and appended drawings describe and illustrate various exemplary embodiments of the invention. The description and drawings serve to enable one skilled in the art to make and use the invention and are not intended to limit the scope of the invention in any manner. In respect of the methods disclosed and illustrated, the steps presented are exemplary in nature, and thus, the order of the steps is not necessary or critical.

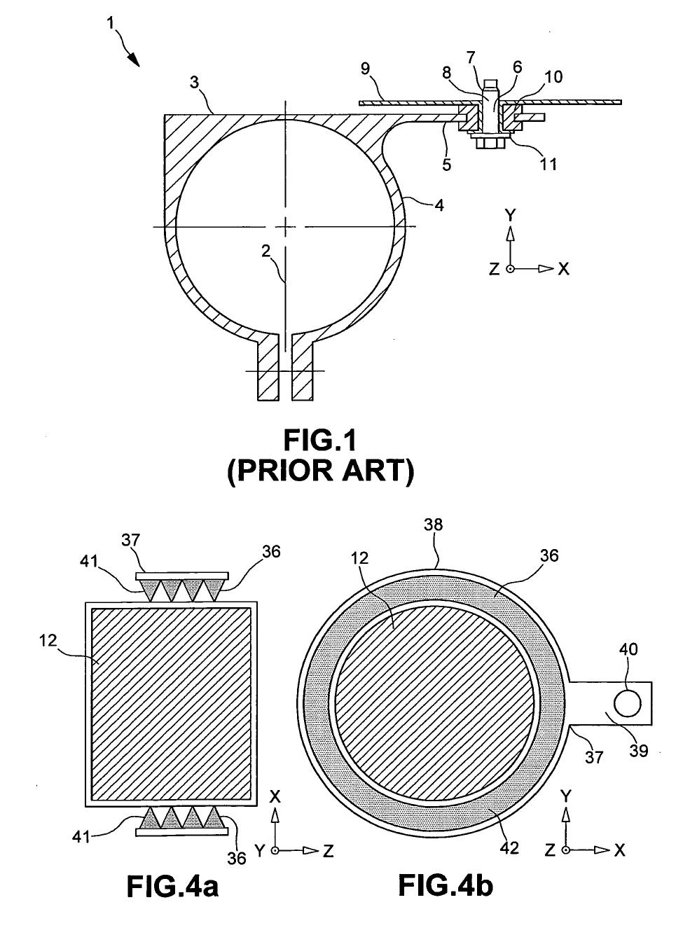

FIG. 1 shows a system 1 for attaching a cylindrical accumulator 2 according to prior art. The cylindrical accumulator 2 is annularly enveloped by a mount 3, which additionally exhibits an attachment projection 5 running tangentially to the annular line 4. The attachment projection 5 has an attachment opening 6. An attachment element 7 that passes through the attachment opening 6 and an opening 8 congruent with the latter in the body wall 9 is used to realize the attachment of the mount 3 to the body wall 9. The attachment projection 5, body wall 9 and attachment element 7 have no direct contact with each another, but are rather cushioned against one another in all three oscillation directions X, Y, Z by a decoupling element 10 that envelops the attachment element 7 and also shifts between the head 11 of the attachment element 7 and the attachment projection 5, and between the attachment projection 5 and the body wall 9 on the other.

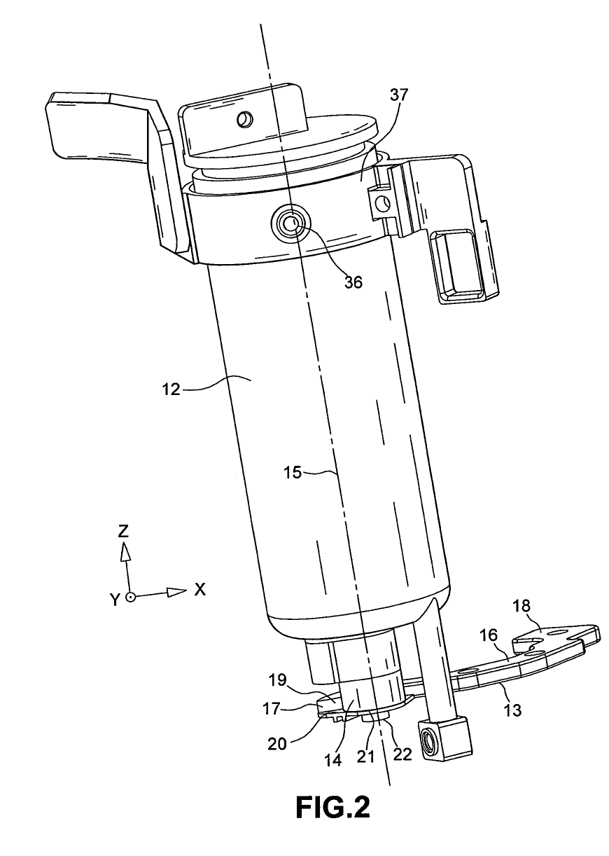

FIG. 2 shows a combined module 12 with mount 13 and decoupling element 14 according to the invention. The mount 13 is attached on one end to the body side without decoupling and the other end of the mount 13 is joined by a decoupling element 14 with the combined module 12 consisting of an accumulator and internal heat exchanger. The primary load imposed by the module weight takes place in the direction of the longitudinal axis 15 of the combined module 12. The decoupling element 14 is arranged in the direction of the primary axis Z, and dampens oscillations in the direction of primary axis Z. On FIG. 2, the decoupling element 14 for the primary axis Z is situated under the combined module 12 near the longitudinal axis 15 of the combined module 12. The mount 12 on FIG. 2 resembles a sickle, the sickle disk surface 16 of which is aligned perpendicular to the longitudinal axis 15 of the combined module 12. A first outer end 17 of the sickle-shaped mount 13 is located under the combined module 12, from where the sickle-shaped mount 13 extends laterally, with its second outer end 18 facing away from the combined module 12. In the area of the first outer end 17 of the sickle-shaped mount 13, the outer surface 19 of the sickle-shaped mount 13 accommodates an attachment projection 20 of the mount 13 for fastening to the bottom side 21 of the cylindrical decoupling element 14. The attachment projection 20 of the mount 13 is secured to the decoupling element 14 with an attachment element 22, wherein the attachment element 22 is introduced from below into the cylindrical decoupling element 14 through an attachment opening in the attachment projection 20 of the mount, parallel to the longitudinal axis of the combined module 12.

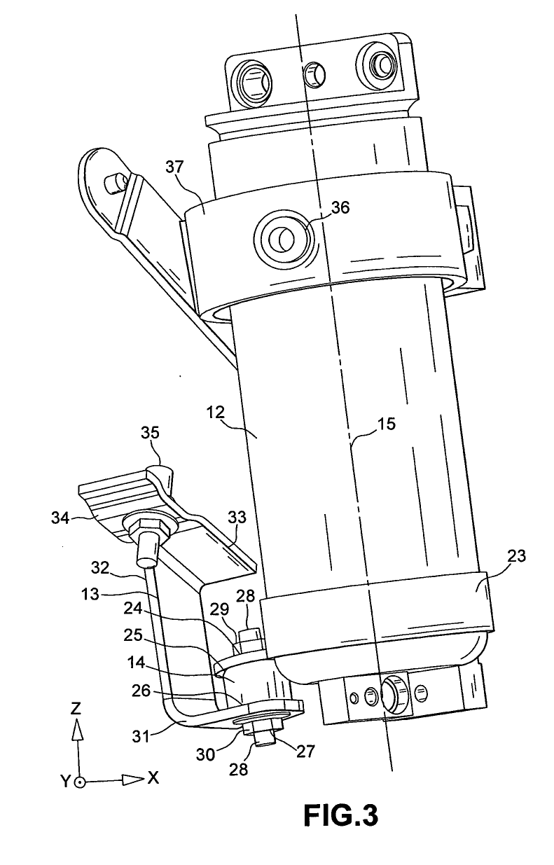

An arrangement as depicted on FIG. 3 is advantageous for reasons of space. The force is transmitted by a clamping ring 23 and a mount 13 to the decoupling element 14 aligned in the direction of the primary axis Z. The clamping ring 23 has an attachment projection, the attachment opening of which lies flat on the surface 25 of the cylindrical decoupling element 14. On the opposing lower side 26 of the decoupling element 14, the attachment opening of the mount 13 is coaxially positioned with the attachment opening of the attachment projection 24 on the clamping ring 23. An attachment element 27 extends longitudinally coaxial through the cylindrical decoupling element 14 and both attachment openings. The attachment element 27 is designed as a screw bolt 28 in the embodiment according to FIG. 3, which accommodates screw nuts 29, 30 screwed onto both the attachment projection 24 on the clamping ring 23 and on the mount 13. The mount 13 is essentially C-shaped with a lower C-leg 31, a C-base leg 32 and an upper C-leg 33. The attachment opening of the mount 13 to be secured to the decoupling element 14 is located on the lower C-leg 31. The upper C-leg 33 has an attachment projection 34 extending laterally out of the latter for securing the mount 13 to the body wall, wherein the attachment is formed without decoupling with an attachment element 35.

FIG. 4 presents sectional views of a system for attaching a combined module 12 with a decoupling element 36 for secondary axes X, Y. FIG. 4a here depicts a section along the X-Z plane of the combined module 12, while FIG. 4b depicts a section along the X-Y plane. The decoupling element 36 for secondary axes X, Y in the X-Y plane is radially aligned relative to the midpoint of the combined module container 12. According to FIG. 4b, the mount 37 annularly envelops the combined module container 12, wherein the annular mount 37 outside the annular zone exhibits an attachment projection 39 with a round attachment opening 40 for securing the mount 37 to the body wall.

The decoupling element 36 on FIG. 4a is shown as an elastic damping section 41 with progressive spring characteristic, which according to FIG. 4b is coaxially arranged in the annular gap 42 between the mount 37 and combined module 12.

What is claimed is:

1. An attachment device for mounting a combined module, the attachment device comprising:
a first mount adapted to be mounted in a vehicle;
a second mount adapted to be mounted in a vehicle and cooperating with said first mount to support the combined module;
a first decoupling element disposed on said first mount to dampen a movement of the combined module in a first direction; and
a second decoupling element disposed on said second mount to dampen the movement of the combined module in a second section and a third direction.

2. The attachment device according to claim 1, wherein the first direction is a primary Z-axis.

3. The attachment device according to claim 1, wherein the second direction is a primary X-axis.

4. The attachment device according to claim 1, wherein the third direction is a primary Y-axis.

5. The attachment device according to claim 1, wherein said first decoupling element is disposed between said first mount and the combined module.

6. The attachment device according to claim 1, wherein said second decoupling device is disposed between said second mount and the combined module.

7. The attachment device according to claim 1, further comprising a clamping ring with a mounting flange disposed on said first mount.

8. The attachment device according to claim 7, wherein the mounting flange and said first decoupling element are in contact and are disposed eccentrically parallel to the first direction.

9. The attachment device according to claim 1, wherein at least one surface of said first decoupling element and said second decoupling element include at least one annular pocket formed therein to facilitate an elastic damping effect.

10. The attachment device according to claim 1, wherein said second mount has a circular shape to receive the combined module.

11. An attachment device for use in a vehicle cooling system, the attachment device comprising:
a combined module including an accumulator and a heat exchanger;
a first mount adapted to be mounted in a vehicle;
a second mount adapted to be mounted in a vehicle and cooperating with said first mount to support said combined module;
a first decoupling element disposed on said first mount to dampen a movement of said combined module in a first direction; and
a second decoupling element disposed on said second mount to dampen the movement of the combined module in a second direction and a third direction.

12. The attachment device according to claim 11, wherein the first direction is a primary Z-axis.

13. The attachment device according to claim 11, wherein the second direction is a primary X-axis.

14. The attachment device according to claim 11, wherein the third direction is a primary Y-axis.

15. The attachment device according to claim 11, wherein said first decoupling element is disposed between said first mount and said combined module.

16. The attachment device according to claim 11, wherein said second decoupling device is disposed between said second mount and said combined module.

17. The attachment device according to claim 11, further comprising a clamping sleeve with a mounting flange attached to said first mount.

18. The attachment device according to claim 17, wherein the mounting flange and said first decoupling element are in contact and are disposed eccentrically parallel to the first direction.

19. The attachment device according to claim 11, wherein at least one surface of said first decoupling element and said second decoupling element include at least one annular pocket formed therein to facilitate an elastic damping.

20. An attachment device for use in a vehicle cooling system, the attachment device comprising:
a combined module including an accumulator and a heat exchanger;
a first mount adapted to be mounted in a vehicle;
a second mount adapted to be mounted in a vehicle and cooperating with said first mount to support said combined module;
a first decoupling element disposed on said first mount to dampen a movement of said combined module in a first direction, wherein the first direction is a primary Z-axis; and
a second decoupling element disposed on said second mount to dampen the movement of said combined module in a second direction and a third direction, wherein the second direction is a primary X-axis and the third direction is a primary Y-axis.
